(19) United States
(12) Patent Application Publication
(10) Pub. No.: US 2006/0163863 A1
(43) Pub. Date: Jul. 27, 2006

(54) Vehicle chassis

(76) Inventors: Siegfried Ellmann, Aschheim (DE); Holger Wehaus, Munchen (DE); Walter Kolb, Kottgeisering (DE)

Correspondence Address: Dr. Max Fogiel, 44 Maple Court, Highland Park, NJ, 08904, US

(21) Appl. No.: 11/107,050

(22) Filed: Apr. 15, 2005

(30) Foreign Application Priority Data
Nov. 28, 2002 (DE) 102 55 764.0
Oct. 29, 2003 (WO) PCT/EP03/11969

(51) Int. Cl. B60G 17/00; B62D 21/11

(52) U.S. Cl. 280/788; 280/6.157; 280/124.179

(57) ABSTRACT

A vehicle chassis with a spring bracket supporting a helical spring braced between two spring plates. a region of a piston and a shock absorber tube is disposed within the helical spring. At least one of the spring plates is axially adjustable by a drive unit having a circular electric motor with a stator and a rotor, and a transmission having a threaded spindle and a threaded screw.

The invention relates to a vehicle chassis with a spring bracket for supporting a helical spring, braced between two spring plates, and a shock absorber, for which a region of the piston rod and/or of the shock-absorber tube is disposed within the helical spring, at least one spring plate being axially adjustable by means of a drive unit, consisting of a circular electric motor, formed form a stator and a rotor and a transmission formed from a threaded spindle and a threaded screw.

The DE-A 195 10 032 discloses a spring bracket within a vehicle chassis, the spring bracket supporting a helical spring, which is braced between two spring plates and comprising at least one axially adjustable spring plate as well as fastenings at the vehicle chassis and the vehicle body, the spring plate being positioned axially by means of a drive unit. An electric motor is used as drive unit here, a transmission being disposed between the axis of rotation of the electric motor and the spring plate. It is a disadvantage of such a spring bracket that much headspace is required between the vehicle body and the upper spring plate, so that the piston rod of the shock absorber or spring strut must be constructed particularly long and, with that, susceptible to bending and breaking, or makes it difficult to use this bracket for spring struts.

Moreover, the spring bracket described here requires a large number of mechanical components, so that the manufacturing costs are high.

In the WO-A 02/08001, a device is described for regulating movements of the body of motor vehicles, the body being supported directly or indirectly at least at one wheel axis over a series connection of an active control element and a supporting spring. The control element is formed by an electromechanical driving mechanism, which is provided axially outside of a spiral spring and is in operative connection with a ball-type linear drive with spindle nut located axially thereunder. Similarly to the DE-A 195 10 032, a relatively large axial headspace is required here also, so that the device of this publication has the same disadvantages.

The DE-C 01 694 discloses a vehicle chassis, containing a spring support for supporting a helical spring braced between two spring plates and a shock absorber, for which a region of the piston rod and/or of the shock-absorber tube is disposed within a helical spring, at least one spring plate being axially adjustable by means of a drive unit, formed from an electric motor and a transmission. The electric motor is constructed as a circular motor with an external stator and an internal rotor. At the inside, the rotor carries a movement nut, which axially adjusts a spring plate support, which is constructed at the outside as a threaded spindle and is connected with the spring plate. The movement nut and the spring plate are constructed here as a ball screw spindle. Admittedly, the axial headspace can be reduced already by these means. However, due to the large axial diameter of the transmission, a high driving moment is necessary.

It is an object of the invention to develop a generic vehicle further, so that larger axial forces can be applied without enlarging the electric motor.

This objective is accomplished with the distinguishing features of claim 1.

Advantageous further developments of the object of the invention are described in the claims 2 to 15.

In comparison to the state of the art, the inventive vehicle chassis with the spring bracket has the advantage that the headspace can be reduced further. By these means, the spring bracket can also be used for conventional suspension strut constructions without any special structural changes. Even for use in normal spring-shock absorber combinations, it is not necessary to use other shock absorbers or other springs if, as an alternative to a normal spring support, an axially adjustable spring bracket is used. Moreover, it is advantageous that the inventive spring bracket has only a few parts and, accordingly, can be produced relatively inexpensively. A further advantage over the state of the art can be seen therein that, due to the larger lever arm now resulting from the larger diameter of the electric circular motor, a larger adjusting moment can be produced.

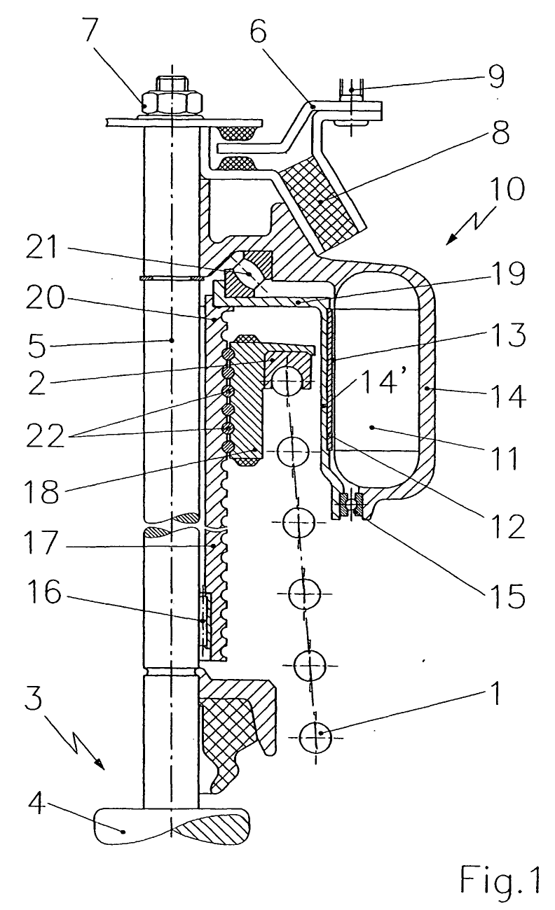

The object of the invention is described in greater detail in the following and shown and, by means of an example, in the drawing in which FIGS. 1 to 3 represent longitudinal sections through differently configured spring brackets, including spring dampers and shock absorbers.

FIGS. 1 to 3 show longitudinal sections through differently configured spring brackets, including springs and shock absorbers, identical components having been provided with identical reference numbers.

The spring bracket, shown in FIG. 1, is intended to accommodate a helical spring 1, one end region of which, in this example, is supported against a spring-retaining collar 2. Centrally within the helical spring 1, a shock absorber 3 is disposed, with an oscillating piston rod 5 dipping axially into a shock absorber tube 4. This shock absorber can be constructed with a fixed damping, specified by design. However, a shock absorber with a variable damping power can also be used. In the lower region, the wheel suspension is fastened by way of a flange, the details of which are not shown. The piston rod 5 is fastened in a known manner by way of components 6 of the vehicle body. For this purpose, the piston rod 5 is screwed by means of a nut 7 onto connecting parts, which are constructed to be angularly resilient and impact resilient and, in turn, are in operative connection by means of threaded bolts 9 with the component 6 of the vehicle body. The spring bracket interacts with an adjusting device 10, which is formed by a circular electric motor comprising a stator 11 as well as a rotor 12, which are disposed within a housing 14 with formation of an air gap 13. The circular motor consists essentially of electric coils, which, together with the laminated core of a transformer, generate an electromagnetic field. The electric coils, the laminated core of the transformer, as well as possibly also censors and electric or electronic components of the control and evaluation electronics may, if necessary, be cast by means of a plastic composition, which cures later on, in the exterior housing 14. The rotor 12 is supported by ball bearings 15 at the housing carrying the stator 11. Radically within the axial headspace of the circular electric motor, there is, on the one hand, a threaded spindle 17, mounted on the piston rod 5, for example, by way of needle bearings 16, as well as a threaded nut 18, the threaded nut 18 being disposed completely and the threaded spindle 17 at least partly within the axial headspace of the housing 14 of the circular electric motor. Instead of the needle bearing 16, it is also possible to use a plain bearing. By these means, the axial headspace of the adjusting device 10 can be reduced appreciably without the need for further expensive components. The needle bearing 16 is disposed here in the lower part of the threaded spindle 17. If necessary, a further needle bearing may also be provided in the upper part of the threaded spindle 17. The axial headspace can be reduced further if the internal diameter of the threaded spindle 17 is larger than the diameter of the shock absorber housing. The threaded spindle 17 can then overlap the shock absorber housing. The inner part 14′ of the housing, carrying the rotor 12, is provided with radial shoulder 19, which is connected non-positively with the upper end region 20 of the threaded spindle 17. A roller bearing 21 extends at the shoulder side between the upper part of the housing 14 and the inner part 14′ of the housing. As a consequence of the rotational movement, carried out by the rotor 12 and, accordingly, the housing part 14′, the threaded spindle 17 is also caused to rotate in the same manner, so that the threaded nut 18 can be moved up and down over the balls 22 provided between it and the threaded spindle 17, as a result of which an axial displacement of the spring-retaining collar 2 is brought about. In this example, the spring-retaining collar 2 is mounted at a radial disk 2′ of the threaded nut 18. The radial disk 2′ is provided radially within the circular electric motor and the rotor 12 respectively.

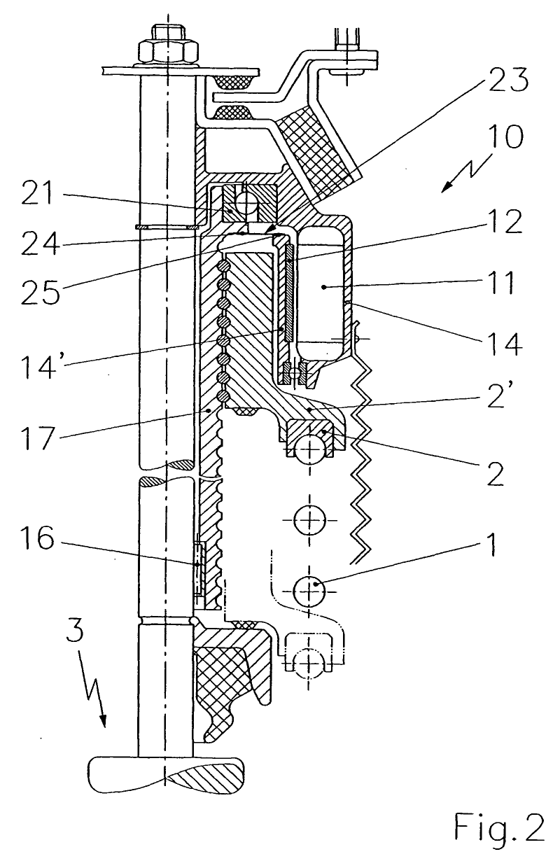

FIG. 2 shows an alternative embodiment of the spring bracket shown in FIG. 1. Contrary to FIG. 1, the adjusting device 10 is provided axially outside of the helical spring 1, the circular electric motor remaining dimensionally approximately within the radial extent of the helical spring 1. Here also, the circular electric motor is formed by a stator 11 and a rotor 12. In this example, the spring-retaining collar 2 or the radial disk 2′ carrying the same are located axially below the housing 14, so that the construction of the adjusting device 10 is compact. Here also a roller bearing 21 is used. Also deviating from FIG. 1, a flexible sheet metal membrane 23 is provided, which is connected by welding 24, 25 on the one hand, firmly with the inner part 14′ of the housing and, on the other hand, with the threaded spindle 17. As for the rest, the further body remains similar to that of FIG. 1.

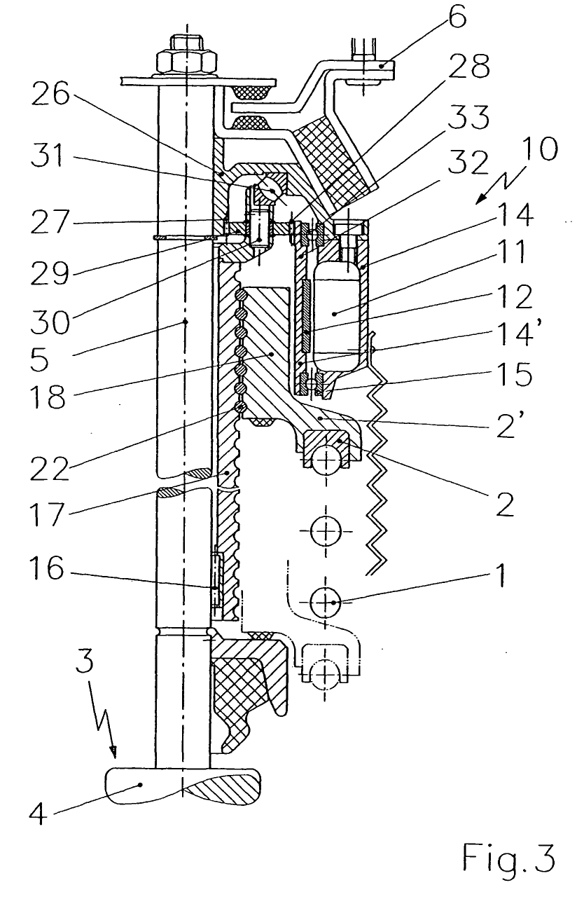

The construction of FIG. 3, differs from that of FIG. 2 owing to the fact that the housing part 14, connected with the rotor 12, is not connected torsionally directly with the threaded spindle 17 of the ball roll gear mechanism.

A planetary gear is provided between these two components. As also for the constructions of FIGS. 1 and 2, the housing 14 of the circular electric motor is supported directly on the upper end of the piston rod 5, as well as at the connecting part 8 supported at the vehicle body.

The downwardly extending part 26 of the casing of the housing 14, surrounding the end of the piston rod 5, is constructed with a gearing transmission 27. A gearing transmission 28 is also provided at the upper end of the housing part 14′. However, it is constructed as an internal gearing. Planet gears 29 also run between these two gearing transmissions 27 and 28. The planet gears 29 are connected over axes 30 with the threaded spindle 17. The solutions can be adapted appropriately by these constructions. The threaded spindle is supported by way of a bearing 31 at the housing 14 of the circular electric motor, this bearing 31, however, being outside of the planetary gearing and, accordingly, also guiding the planetary gearing and, accordingly, also guiding the planetary gearing. For the construction of FIG. 3, the upper part 32 of the inner part 14′ of the housing is then supported by a further bearing 33 with respect to the housing 14, as a result of which the gearing transmission 28, disposed at this upper part 33, is also supported.

By interposing the planetary gearing, shown in FIG. 3, between the rotor 12 and the ball roll transmission, a further large gear ratio reduction is created, so that the torque of the circular electric motor, which is to be applied, can be reduced significantly once again. The remaining parts of the adjusting device 10 are not changed functionally.

If required technically, the adjusting device can also be equipped with an electromagnetic or mechanical brake, especially in the area of the circular electric motor. An unintentional adjustment of the adjusting device after failure of the vehicle electronics or after the motor is switched off is to be prevented by this brake, which is constructed in the usual way, the details of which are not shown.

In order to optimize the load on the on-board power supply, provisions can furthermore be made that the circular electric motor is connected as a generator, so that, during the pitching or rolling motions of the vehicle body, energy is recovered. As is well known, torsion bar stabilizers at the front and/or rear axle may be omitted if inventive adjustable spring brackets are installed. The devices described are also particularly suitable for accommodating sensors, control elements and data transfer devices for controlling the suspension. Even further advantages can be achieved by selecting suitable materials of construction for the ball screw spindle and the circular electric motor. For example, an improvement in dynamics can be achieved by using composite materials for the rotor and connecting the latter to the threaded spindle. A better dissipation of heat and a reduction in production costs can be achieved if the pressure-gelling technique is used to construct the stator and the housing.

List of Reference Numbers

1 helical spring
2 spring bracket
2′ radial disk
3 shock absorber
4 shock absorber
5 piston rod
6 component of vehicle body
7 nut
8 connection part
9 threaded bolt
10 adjusting device
11 stator
12 rotor
13 air gap
14 housing
14′ inner part of housing
15 ball bearing
16 needle bearing
17 threaded spindle
18 threaded nut
19 radial shoulder
20 upper end region
21 roller bearing
22 balls
23 flexible sheet metal membrane
24 welding spot
25 welding spot
26 part
27 gearing transmission
28 gearing transmission
29 planet gear
30 axis
31 bearing
32 upper part
33 bearing

1. Vehicle chassis with a spring bracket for supporting a helical spring (1), braced between two spring plates (2), and a shock absorber (3), for which a region of the piston rod (5) and/or of the shock-absorber tube (4) is disposed within the helical spring (1), at least one spring plate (2) being axially adjustable by means of a drive unit, consisting of a circular electric motor, formed form a stator (13) and a rotor (12) and a transmission formed from a threaded spindle (17) and a threaded nut (18), characterized in that the threaded nut (18) and at least also a portion of the threaded spindle (17) are provided, on the one hand, radially within the helical spring (1) and, on the other, radially within the region of the axial extent of the circular electric motor.

2. The vehicle chassis of claim 1, characterized in that the threaded nut (18) carries in the region of the circular electric motor a radial disk (2′), which is intended for mounting the one end region of the helical spring (1).

3. The vehicle chassis of claims 1 or 2, characterized in that the circular electric motor is in operative connection with the threaded spindle (17) over a bearing (21), which is constructed particularly a roller bearing.

4. The vehicle chassis of one of the claims 1 to 3, characterized in that the rotor (12) of the circular electric motor is in operative connection with the threaded spindle (17) over a radial shoulder (19) carrying the bearing (21).

5. The vehicle chassis of one of the claims 1 to 4, characterized in that the rotor (12) is in operative connection with the threaded spindle (17) over a component, which is radially and rotationally stiff and axially and cardanically soft.

6. The vehicle chassis of claim 5, characterized in that the rotor (12) is in operative connection with the threaded spindle (17) over a flexible sheet metal membrane (23).

7. The vehicle chassis of one of the claims 1 to 6, characterized in that the circular electric motor is disposed axially above the helical spring (1) and, from the point of view of its radial dimensions, remains approximately within the diameter range of the helical spring (1).

8. The vehicle chassis of one of the claims 1 to 7, characterized in that the circular electric motor is provided in the region of the upper spring-retaining collar (2) and surrounds the helical spring (1) at a specifiable radial distance.

9. The vehicle chassis of one of the claims 1 to 8, characterized in that a planetary gearing is connected between the circular electric motor and the ball roll transmission.

10. The vehicle chassis of claim 9, characterized in that the gearing transmission (27) of the sun gear is mounted at the casing of the housing (14) surrounding the piston rod and the gearing transmission (28) of the outer wheel is mounted at the housing part (14) of the rotor (12) and the mounting of the planet gear (29) is connected with the threaded spindle (17) of the ball roll transmission.

11. The vehicle chassis of one of the claims 1 to 10, characterized in that one of the parts rotating against one another is constructed with a braking device.

12. The vehicle chassis of claim 11, characterized and that the rotor (12) of the circular electric motor is constructed with a braking device.

13. The vehicle chassis of claims 11 or 12, characterized in that the braking device is operated electrically or electromechanically.

14. The vehicle chassis of one or more of claims 1 to 13, characterized in that the end of the threaded spindle (17), opposite the connection of the circular electric motor to the rotor (12), is mounted rotatably on the piston rod (5).

15. The vehicle chassis of one or more of the claims 1 to 13, characterized in that the internal diameter of the threaded spindle (17) is larger than the external diameter of the shock absorber housing and that the threaded spindle (17) overlaps at least sectionally the shock absorber housing.
